(19) United States
(12) Patent Application Publication
(10) Pub. No.: US 2021/0285497 A1
(43) Pub. Date: Sep. 16, 2021

(54) Bearing Unit With Optimized Clamping System

(71) Applicant: Aktiebolaget SKF, Goteborg (SE)

(72) Inventors: Fausto Baracca, Massa (IT); Andrea A. Bertolini, Carrara (IT); Fabio Falaschi, Carrara (IT); Pasquale Frezza, Aversa (CE) (IT)

(21) Appl. No.: 17/196,361

(22) Filed: Mar. 9, 2021

(30) Foreign Application Priority Data
Mar. 16, 2020 (IT) 102020000005509

(51) Int. Cl. F16C 33/78

(52) U.S. Cl. CPC F16C 33/7806

(57) ABSTRACT

A bearing unit having a radially outer ring which is stationary, a radially inner ring, rotatable around a central rotation axis (X) of the bearing unit, provided, in an end portion thereof, with at least two segments of circular sectors separated by at least two grooves, a row of rolling elements interposed between the radially outer ring and the radially inner ring, and a collar for clamping the radially inner ring on to a shaft; each circular sector segment is provided with a lip having a thickness (s) and a step having a thickness (s+s1), wherein the thickness (s+s1) of the step is greater than the thickness (s) of the lip.

### CROSS-REFERENCE RELATED APPLICATION

This application is based on and claims priority to Italian Patent Application No. 102020000005509, filed on Mar. 16, 2020, under 35 U.S.C. § 119, the disclosure of which is incorporated by reference herein.

### FIELD

The present disclosure relates to bearing units provided with a collar for clamping the radially inner ring on to a rotating shaft. Such bearing units are suitable for applications in the manufacturing sector and especially in the agricultural sector, since it is simple and economical to produce.

### BACKGROUND

There are known bearing units provided with rolling elements and systems for clamping the unit on to a rotating shaft.

Bearing units are used to allow the relative movement of a component or assembly with respect to another component or assembly. As a rule, the bearing unit has a first component, for example a radially inner ring, which is fixed to a first component, for example a rotating shaft, and a second component, for example a radially outer ring, which is fixed to a second component, for example a stationary housing. Typically, as in the aforementioned examples, the radially inner ring is rotatable, while the radially outer ring is stationary, but in many applications the outer element rotates and the inner element is stationary. In any case, in rolling bearing units, the rotation of one ring with respect to the other is allowed by a plurality of rolling elements that are positioned between the cylindrical surface of one component and the cylindrical surface of the second component, these surfaces usually being called races. The rolling elements may be balls, cylindrical or tapered rollers, needle rollers, or similar rolling elements.

### BRIEF DESCRIPTION OF THE DRAWINGS

Various embodiments will now be described with reference to the attached drawings, which show some non-limiting examples of embodiments of the housing element, in which:

FIG. 1 shows, in cross section, a bearing unit provided with a clamping collar in accordance with this disclosure.

FIG. 2 shows, in an axonometric view, the bearing unit of FIG. 1 without the collar, so that the circular sector segments of the radially inner ring are visible,

FIG. 3 is a detail of the end of a radially inner ring, showing the lip and the step of the circular sector segments, and

FIG. 4 is an axonometric view, the bearing unit provided with a collar, as in FIG. 1, in which the means for clamping the collar around the circular sector segments of the radially inner ring are visible.

### DETAILED DESCRIPTION

Bearing units having a clamping collar for mounting on a rotating shaft are a simpler and more economical solution than one providing for the forced interference coupling of the radially inner ring to the rotating shaft. However, the use of a clamping collar has drawbacks due to the amount of noise generated and the amount of excessive vibrations inherent in such a solution that may damage the shaft on which they are fitted. In an attempt to overcome these problems, one solution consists in shaping a terminal portion of a radially inner ring with a plurality of segments of circular sectors spaced apart by grooves, in other words a series of “slotted fingers” on which a clamping collar is engaged. The greater flexibility of these circular sector segments facilitates the bending of said segments against the shaft when the locking collar is fitted and clamped.

This solution is not optimal, because it has been reducing the thickness of the circular sector segments sufficiently to provide the necessary flexibility creates a risk of excessively weakening a terminal portion of a radially inner ring that may cause it to break as a result of excessive clamping.

Other solutions, for example providing the collar with a double inside diameter, or forming an inner groove in the terminal portion of an inner ring, have also failed to yield satisfactory results.

Consequently there is a need to design a bearing unit provided with a clamping collar such that the clamping is reliable in terms of mechanical strength, while making the shaft and the radially inner ring concentric and avoiding the generation of excessive noise and/or vibration.

Embodiments of this disclosure provide a bearing unit comprising a clamping collar that has characteristics that make the clamping more effective, thus being free of the drawbacks described above.

In embodiments of this disclosure, the radially inner ring is provided with a plurality of circular sector segments, spaced apart by grooves, in a terminal portion, which is the portion coming into contact with the clamping collar. These segments comprise a lip and are strengthened by a thickened terminal edge, also referred to a “step” below. The step of each circular sector segment represents the area of the circular sector segments subject to contact with the clamping collar. With this novel profile, it is possible to impart sufficient mechanical strength to the circular sector segments to withstand high clamping moments, together with sufficient flexibility to ensure precise, noise-free clamping.

Suitable design of the lip and the terminal step further improves the present solution.

According to embodiments of this disclosure, a bearing unit, provided with a clamping collar and comprising a radially inner ring having the characteristics stated in the attached claims, is produced.

The bearing unit according to the present disclosure is provided with rolling elements and has an optimized clamping system providing for the use of a collar that can grip and clamp on to the shaft a plurality of segments of circular sectors, spaced apart by grooves, of the radially inner ring.

An embodiment of a bearing unit according to the present disclosure will now be described, purely by way of example, with reference to the aforesaid figures.

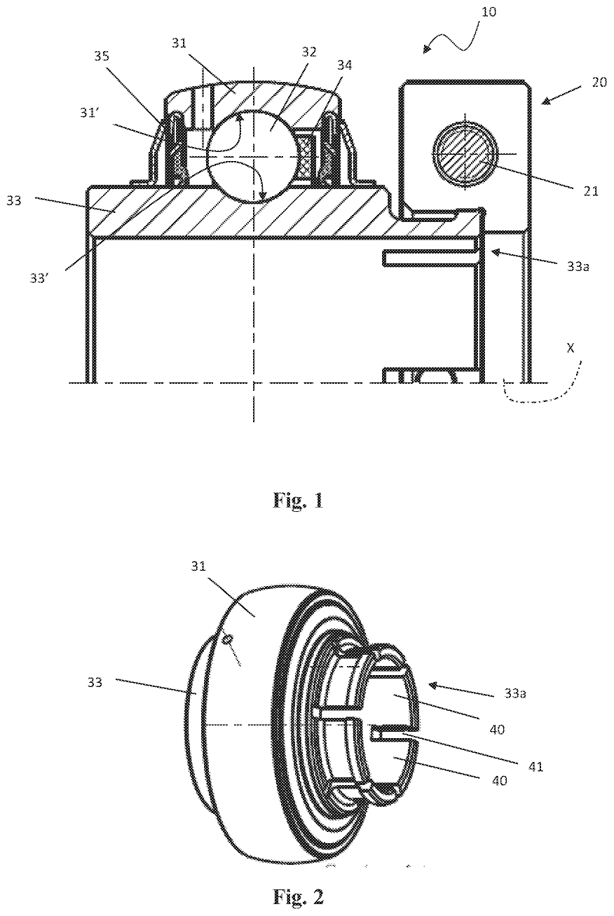

With particular reference to FIG. 1, the bearing unit 10 for applications in the agricultural sector and/or in manufacturing industry—for example, the textile, mining, motor vehicle or food industry—may be interposed, for example, between a rotating shaft and a housing element not forming part of the present invention, and comprises:

a radially outer ring 31 which is stationary, a radially inner ring 33, rotatable about a central axis of rotation X of the bearing unit 10, a row of rolling elements 32, in this case balls, interposed between the radially outer ring 31 and the radially inner ring 33, a cage 34 for containing the rolling bodies, in order to keep the rolling elements of the row of rolling bodies 32 in position, a collar 20 for clamping the radially inner ring on the shaft.

Throughout the present description and the claims, terms and expressions indicating positions and orientations such as “radial” and “axial” are to be interpreted as relating to the central axis of rotation X of the bearing unit 30.

The radially outer ring 31 is provided with a radially outer race 31′, while the radially inner ring 33 is provided with a radially inner race 33′ to allow the rolling of the row of rolling elements 32 interposed between the radially outer ring 31 and the radially inner ring 33. For simplicity of illustration, the reference 32 will be applied both to the individual balls and to the row of balls. Also for simplicity, the term “ball” may be used by way of example in the present description and in the attached drawings in place of the more generic term “rolling element” (and the same reference numerals will also be used).

The bearing unit 10 is also provided with sealing means 35 for sealing the bearing unit from the external environment. In the following text, the sealing means 35 may be referred to even more simply as seals 35, although this evidently signifies the same component.

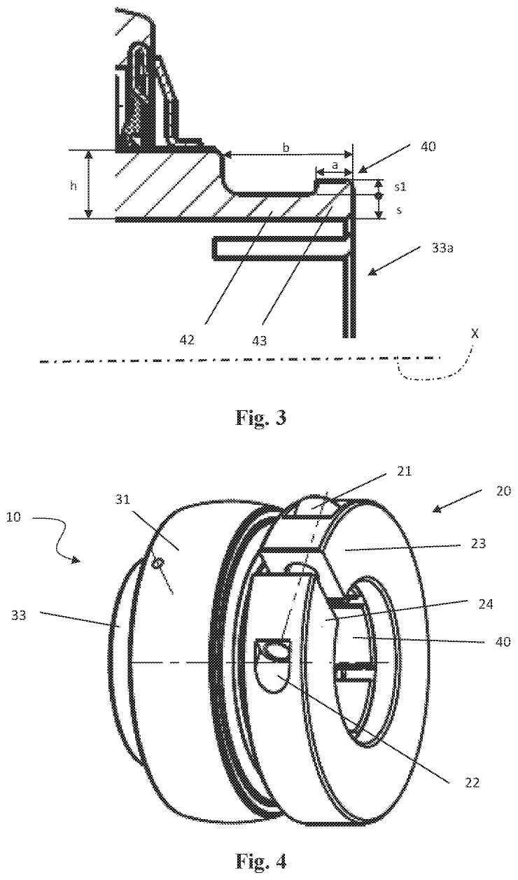

As mentioned above, the clamping collar 20 has the function of clamping a terminal portion 33a of the radially inner ring 33 on to a rotating shaft. According to the present invention, and with particular reference to FIGS. 2 and 3, the radially inner ring 33 is provided, in its terminal portion 33a, with a plurality of circular sector segments 40, spaced apart by grooves 41. There are at least two, or preferably from six to eight, of these segments 40; the number of grooves 41 will therefore be the same.

Each segment 40 comprises a lip 42 having a thickness s, and is strengthened by a step 43 having a thickness s+s1, where s1 represents the additional thickness of the step 43 relative to the lip 42. The step 43 of each circular sector segment 40 represents the area of the circular sector segments subject to contact with the clamping collar 20. This profile formed on the circular sector segments 40 makes it easier to meet the requirement for the clamping collar 20 to remain in position during the procedure of mounting on the shaft. Usually, the clamping collar moves spontaneously during the mounting procedure and slides on the segments 40.

A first significant characteristic for the design of the circular sector segments 40 is the thickness s of the lips 42. The thickness s must be small in order to allow each circular sector segment 40 to be more flexible. This characteristic, together with the fact that the material is not hardened, but is soft, ensures better locking of the radially inner ring 33, reducing vibrations and allowing greater power transmission.

By way of example, the following table shows the thickness s of the lips 42 as a function of the size of the bearing unit:

| Size of bearing unit | Thickness of lips (s) |
|---|---|
| 205-206 | 1.6 mm |
| 207-208 | 1.8 mm |
| 209-212 | 2 mm |
| 214 | 2.5 mm |
| 215-216 | 2.7 mm |
| 218 | 3.5 mm |

As a general rule, if h denotes the thickness of the radially inner ring 33, the ratio between the thickness s of the lips 42 and the thickness h of the radially inner ring is between 27% and 40%. Values below 27% would reduce the strength of the circular sector segments 40, especially in applications requiring high clamping moments. Conversely, values of the ratio s/h in excess of 40% would eliminate the desired flexibility of the circular sector segments 40. This percentage normally increases with an increase in the size of the bearing unit.

A second important characteristic for the design of the circular sector segments 40 is the axial length a of the steps 43. Advantageously, this dimension should be between 25% and 35% of the axial length b of the circular sector segments 40. Values below 25% would reduce the strength of the steps 43 against the clamping action of the collar 20. Conversely, values of the ratio a/b in excess of 35% would reduce the axial length of the lips 42, and would again adversely affect the flexibility of the circular sector segments 40. This ratio also normally increases with an increase in the size of the bearing unit.

The thickness of the steps 43, as has been stated, is made up of the thickness s of the lips 42 with the addition of a quantity s1. This additional thickness s1 represents a parameter that can be adapted to the type of collar 20 to be used. In other words, the additional thickness s1 of the steps 43 is calculated to minimize the number of clamping collars 20 to be used, thus enabling the same collar 20 to be used for bearing units of slightly different sizes. For example, there may be sizes that are fairly similar to each other but not identical, because the first is expressed in metric units and the second is expressed in British imperial units.

Advantageously, the value of the additional thickness s1 of the step 43 should not exceed 50% of the value of the thickness s of the lip 42.

With reference to FIG. 4, the collar 20 is clamped around the circular sector segments 40 by known methods, that is to say using screw means 21, for example a hexagon socket cap screw of the “torx” type. The collar 20 is also provided with a groove 22 in relief. The collar, fitted on top of the radially inner ring 33 and, in particular, on top of the circular sector segments 40, locks the radially inner ring 33 of the bearing unit 10 on the shaft in a concentric way, without causing damage and/or burring, and provides a 360° clamping force on the shaft with a minimum travel of its arms 23, 24, in order to reduce vibrations to a minimum.

In the final analysis, this novel profile of the circular sector segments provides a better performance of the clamping system, in terms of transmissible power and vibration levels, than the prior art. The novel profile of the circular sector segments is more flexible, enabling the closure of the circular sector segments to be increased while using the same clamping torque of the screws acting on the collar.

In functional terms, the embodiments of this disclosure make it possible to obtain a “concentric” solution with all the resulting benefits, as follows: coincidence of the shaft and the axis of the bearing unit with each other; the speed and the nominal limit loads are independent of the tolerance on the shaft; a constant or alternating direction of rotation may be used; the reduced vibration level does not damage the shaft; reduction of friction corrosion; and ease and speed of assembly.

The illustrated solution also yields savings of production costs, and particularly of the costs of various heat treatments (cementation, induction hardening, etc.), since the surface to be subjected to hardening is reduced to the races alone, where the rolling elements come into contact with the radially inner ring.

The object of the present invention is to provide a bearing unit comprising a clamping collar that has characteristics that make the clamping more effective, thus being free of the drawbacks described above.

According to various embodiments, the radially inner ring is provided with a plurality of circular sector segments, spaced apart by grooves, in a terminal portion, which is the portion coming into contact with the clamping collar. These segments comprise a lip and are strengthened by a thickened terminal edge, also referred to a “step” below. The step of each circular sector segment represents the area of the circular sector segments subject to contact with the clamping collar. With this novel profile, it is possible to impart sufficient mechanical strength to the circular sector segments to withstand high clamping moments, together with sufficient flexibility to ensure precise, noise-free clamping.

Suitable design of the lip and the terminal step further improves the present solution.

According to the present invention, a bearing unit, provided with a clamping collar and comprising a radially inner ring having the characteristics stated in the attached claims, is produced.

In addition to the embodiments described above, it is to be understood that numerous other variants exist. It is also to be understood that said embodiments are provided solely by way of example and do not limit the object of the invention or its applications or its possible configurations. On the contrary, although the description given above enables those skilled in the art to implement the present invention according to at least one example of its configurations, it is to be understood that numerous variations of the components described may be envisaged without thereby departing from the object of the invention as defined in the appended claims, interpreted literally and/or according to their legal equivalents.

What is claimed is:

1. A bearing unit comprising:
a radially outer ring, wherein the radially outer ring is stationary;
a radially inner ring, wherein the radially inner ring is rotatable around a central rotation axis (X) of the bearing unit, in an end portion thereof, and is provided with at least two segments of circular sector separated by at least two grooves;
a row of rolling elements interposed between the radially outer ring and the radially inner ring; and
a collar to clamp the radially inner ring on a rotating shaft;
wherein each segment of circular sector comprises a lip having a thickness (s) and a step having a thickness (s+s1), wherein the thickness (s+s1) of the step is greater than the thickness (s) of the lip.

2. The bearing unit according to claim 1, wherein the ratio between the thickness (s) of the lip and a thickness (h) of the radially inner ring is between 27% and 40%.

3. The bearing unit according to claim 1, wherein an axial length (a) of the step is between 25% and 35% of an axial length (b) of the segment of circular sector.

4. The bearing unit according to claim 2, wherein an axial length (a) of the step is between 25% and 35% of an axial length (b) of the segment of circular sector.

5. The bearing unit according to claim 1, wherein the value of an incremental thickness (s1) of the step is less than or equal to 50% of the value of the thickness (s) of the lip.

6. The bearing unit according to claim 2, wherein the value of an incremental thickness (s1) of the step is less than or equal to 50% of the value of the thickness (s) of the lip.

7. The bearing unit according to claim 3, wherein the value of an incremental thickness (s1) of the step is less than or equal to 50% of the value of the thickness (s) of the lip.

8. The bearing unit according to claim 4, wherein the value of an incremental thickness (s1) of the step is less than or equal to 50% of the value of the thickness (s) of the lip.

9. The bearing unit according to claim 1, wherein the segments of circular sector and the grooves are in a number comprised between six and eight.

10. The bearing unit according to claim 2, wherein the segments of circular sector and the grooves are in a number comprised between six and eight.

11. The bearing unit according to claim 3, wherein the segments of circular sector and the grooves are in a number comprised between six and eight.

12. The bearing unit according to claim 4, wherein the segments of circular sector and the grooves are in a number comprised between six and eight.

13. The bearing unit according to claim 5, wherein the segments of circular sector and the grooves are in a number comprised between six and eight.

14. The bearing unit according to claim 6, wherein the segments of circular sector and the grooves are in a number comprised between six and eight.

15. The bearing unit according to claim 7, wherein the segments of circular sector and the grooves are in a number comprised between six and eight.

16. The bearing unit according to claim 8, wherein the segments of circular sector and the grooves are in a number comprised between six and eight.

17. A radially inner ring, rotatable around a central rotation axis (X) of a bearing unit, in an end portion thereof, the radially inner ring comprising:
at least two segments of circular sector separated by at least two grooves;
wherein each segment of circular sector comprises a lip having a thickness (s) and a step having a thickness (s+s1), further wherein the thickness (s+s1) of the step is greater than the thickness (s) of the lip, further wherein an axial length (a) of the step is between 25% and 35% of an axial length (b) of the segment of circular sector, and wherein the value of an incremental thickness (s1) of the step is less than or equal to 50% of the value of the thickness (s) of the lip.

18. A radially inner ring, rotatable around a central rotation axis (X) of a bearing unit, in an end portion thereof, the radially inner ring comprising:
at least two segments of circular sector separated by at least two grooves;
wherein each segment of circular sector comprises a lip having a thickness (s) and a step having a thickness (s+s1), further wherein the thickness (s+s1) of the step is greater than the thickness (s) of the lip, further wherein an axial length (a) of the step is between 25% and 35% of an axial length (b) of the segment of circular sector, and wherein the value of an incremental thickness (s1) of the step is less than or equal to 50% of the value of the thickness (s) of the lip, wherein the segments of circular sector and the grooves are in a number comprised between six and eight.
